(19) United States
(12) Patent Application Publication
(10) Pub. No.: US 2009/0073685 A1
(43) Pub. Date: Mar. 19, 2009

(54) No-power-interrupted lamp string

(76) Inventor: Wun Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,776

(22) Filed: Sep. 6, 2007

(51) Int. Cl. F21S 4/00

(52) U.S. Cl. 362/227

(57) ABSTRACT

A non-power-interrupted lamp string, especially indicates a structure which is able to secure electrical circuit conduction of the lamp string while bulbs are fallen off. Mainly, a fixed plate-terminal and an elastic movable plate-terminal is assembled separately in the interior of each lamp assembly to form an effective clip connection by the elastic contacting of movable plate-terminal to fixed plate-terminal while the lamp is fallen off from the lamp. And, the electrical circuit conduction of the lamp string is secured after the provision of a non-power-interrupted electrical circuit conduction.

### BACKGROUND OF THE INVENTION

The ordinary decoration lamp strings mainly utilize electrical wires to connect several lamp assemblies, and a bulb is assembled in each lamp assembly to form a conductive circuit after providing the electricity and each bulb is thus lightened.

The bulb itself is also a link part of the electrical circuit in this structure. The electrical circuit will break off while any one of the bulbs is fallen off, and result in no function in the whole lamp strings. Therefore, there are now several kinds of different designs mainly are purposed to solve the above problems. For example, as described in FIG. 1 to FIG. 3, two symmetrical elastic plate-terminals (1) are mounted in the interior of lamp assembly (2). Two elastic plate-terminals (1) will be elastically contacted to secure the conductive connection without open circuit.

Also as described in FIG. 4 to FIG. 6, there is another know structure including different types of two elastic plate-terminals (4) which has the same functions and effects as the previous description and all use the elastic contact of two plate-terminals to obtain the non interrupted conductive connection effect.

The disadvantage of the know structure is that the elastic contact between two elastic plate-terminals is the point contact and more unstable, and the function will lose while anyone of the plate terminals slightly loses its elasticity thus is unable to contact with each other and results in breaking off the electrical conduction of the lamp string.

### SUMMARY OF THE INVENTION

Therefore, the main object of this invention is to provide a non-power-interrupted lamp string with innovative structure to ensure no power breaking off while bulbs in the lamp string are fallen off That is, two plate-terminals can be connected securely and effectively to form a conductive electrical circuit.

We now accommodate the drawings to describe the structures and characteristics of the present invention as below:

### BRIEF DESCRIPTION OF THE DRAWINGS

FIG. 1 is a perspective view showing a first known structure of the elastic plate-terminals.

FIG. 2 is an assembled cross-sectional plan view of FIG. 1 received in a lamp assembly.

FIG. 3 is a cross-sectional view of FIG. 1 after the bulb is fallen off.

FIG. 4 is a perspective view showing a second known structure of the elastic plate-terminals.

FIG. 5 is an assembled cross-sectional plan view of FIG. 4 received in a lamp assembly.

FIG. 6 is a cross-sectional view of FIG. 4 after the bulb is fallen off.

FIG. 7 is a perspective view showing the two plate-terminals according to the present invention.

FIG. 8 is an assembled cross-sectional plan view of FIG. 7 received in a lamp assembly.

FIG. 9 is a cross-sectional view of FIG. 7 after the lamp is fallen off.

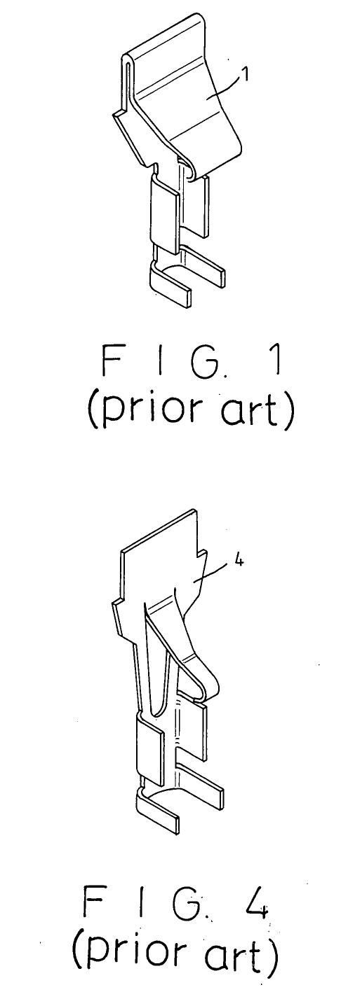

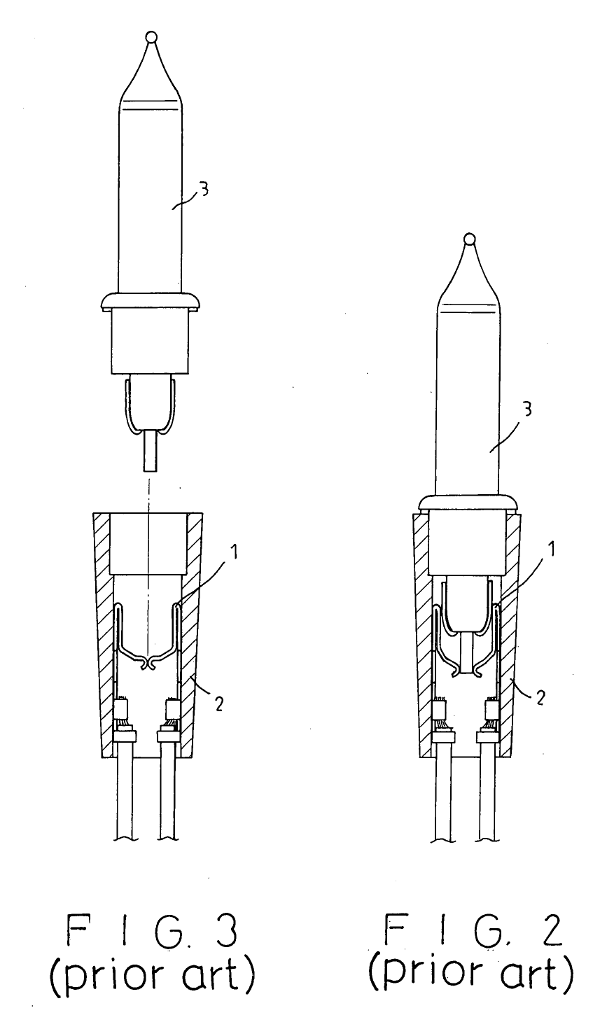

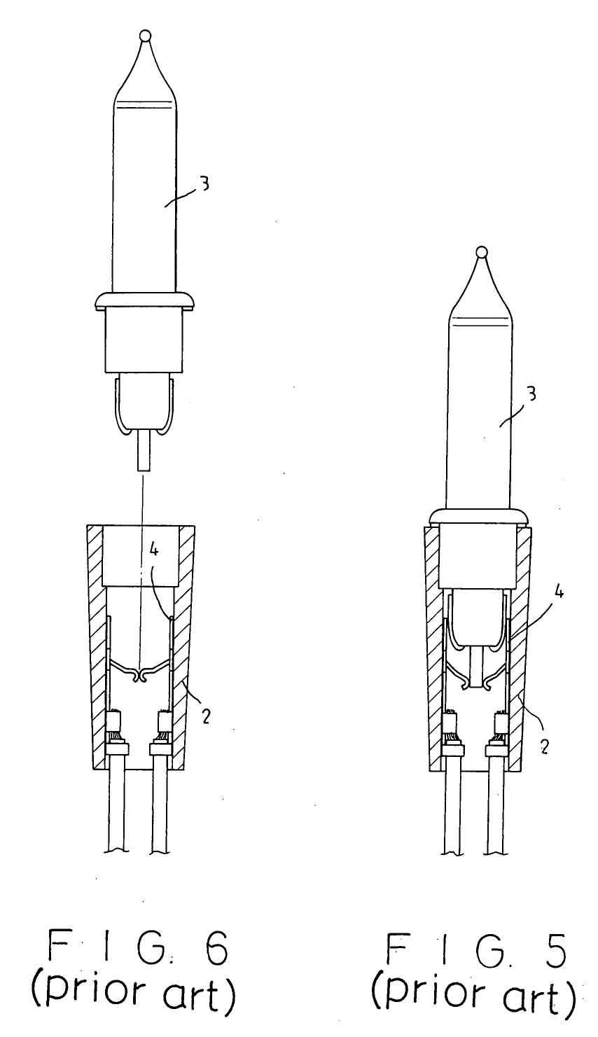

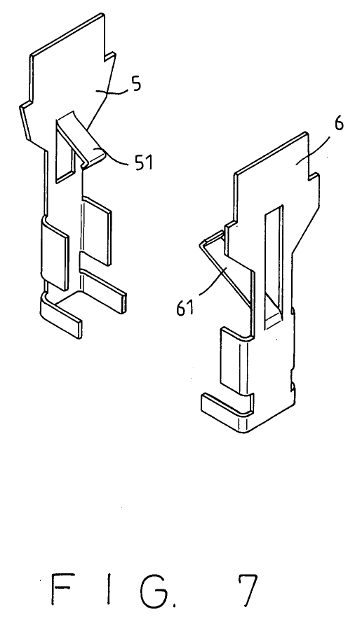

### DETAILED DESCRIPTION OF THE PREFERRED EMBODIMENT

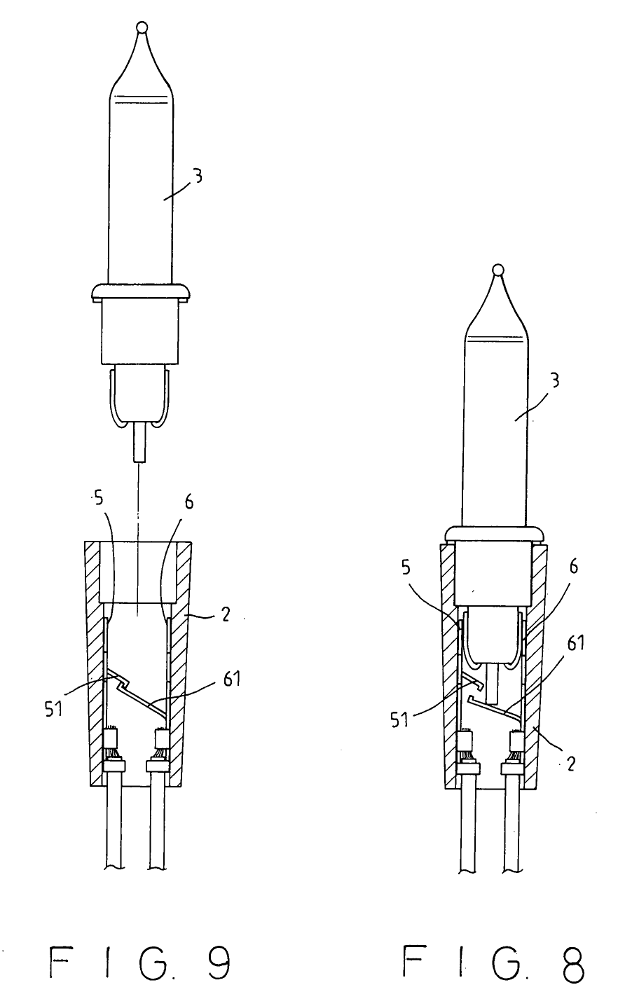

Please refer those shown in FIG. 7 to 9. The present invention includes a lamp assembly (2), a bulb (3), a fixed plate-terminal (5) and a movable plate-terminal (6). Wherein, the fixed plate-terminal (5) with an elastic downward L typed plate (51) is mounted at one side of the interior of the lamp assembly (2), and the movable plate-terminal (6) with an upward inclined elastic L typed plate (61) is mounted at another side of the interior of the lamp assembly (2).

Therefore, the upward inclined elastic L typed plate (61) of the movable plate-terminal (6) will spring upward and clip-assemble with the L typed plate (51) located above after the bulb (3) is fallen off from the lamp assembly (2) as shown in FIG. 9.

Under this situation, the electrical conduction can be secured owing to that a plane contact with better stability is formed while these two plate-terminals are clip-assembled. Thus, the continuous electrical conduction is provided to the lamp string and the no-power-interrupted effect is achieved.

In general, the present invention mainly is to design a structure which is completely different from the know structure. It utilizes the mode of one fix and one moving to form a stable and plane typed clip contact between two plate-terminals in the lamp bases. It thus can achieve the confirmed effect of upraising the electrical conductivity and have the obvious advancement. It should have conformed to the requirement for patent approval. Therefore, we file the patent application according to the law.

I claim:

1. A non-power-interrupted lamp string comprising of several lamp assemblies connected by electrical wires and each lamp assembly can assemble with a bulb, and is characterized in that a fixed plate-terminal and an elastic movable plate-terminal being mounted in the interior of each lamp assembly, wherein the fixed plate-terminal is mounted with a downward L typed plate on, and the movable plate-terminal is mounted with an upward inclined L typed plate; the movable L typed plate is springing upward and tightly clipped to the L typed plate of the fixed plate-terminal while the lamp assemblies are not assembled with the bulb groups.
